(19) United States
(12) Patent Application Publication
(10) Pub. No.: US 2014/0219458 A1
(43) Pub. Date: Aug. 7, 2014

(54) AUDIO SIGNAL REPRODUCTION DEVICE AND AUDIO SIGNAL REPRODUCTION METHOD

(71) Applicant: PANASONIC CORPORATION, Osaka (JP)

(72) Inventors: Naoya TANAKA, Osaka (JP); Hikaru USAMI, Osaka (JP)

(73) Assignee: PANASONIC CORPORATION, Osaka (JP)

(21) Appl. No.: 14/249,881

(22) Filed: Apr. 10, 2014

Related U.S. Application Data
(63) Continuation of application No. PCT/JP2012/006520, filed on Oct. 11, 2012.

(30) Foreign Application Priority Data
Oct. 17, 2011 (JP) 2011-228326

(51) Int. Cl. H04S 5/00

(52) U.S. Cl. CPC H04S 5/00
USPC 381/17

(57) ABSTRACT

An audio signal reproduction device includes: a signal obtainment unit which obtains channel signals including a channel signal representing a direct sound; a reflected sound signal generation unit which, when a first area includes a sound image of the direct sound and a second area is an area other than the first area, generate a reflected sound signal representing a reflected sound, the reflected sound being a sound which reaches the listener after the direct sound is reflected at a predetermined position in the second area; a signal generation unit which generates, from the reflected sound signal, a signal to be outputted to a corresponding channel so that the listener perceives that the reflected sound comes from the predetermined position, the at least one of the channels corresponding to the at least one of the speakers.

### CROSS REFERENCE TO RELATED APPLICATION(S)

This is a continuation application of PCT International Application No. PCT/JP2012/006520 filed on Oct. 11, 2012, designating the United States of America, which is based on and claims priority of Japanese Patent Application No. 2011-228326 filed on Oct. 17, 2011. The entire disclosures of the above-identified applications, including the specifications, drawings and claims are incorporated herein by reference in their entirety.

### FIELD

The present disclosure relates in particular to an audio signal reproduction device and an audio signal reproduction method for expanding a reproduction sound field and realizing high presence in multichannel audio reproduction.

### BACKGROUND

With the spread of recording media such as a digital versatile disc (DVD) and a blue-ray (registered trademark) disc (BD) and digital television broadcasting, a demand for the multichannel audio reproduction is increasing. A format most widely used as a multichannel audio signal is called 5.1 channel surround.

In 5.1 channel surround, a left channel (L channel), a center channel (C channel), and a right channel (R channel) are provided ahead of a listener. Moreover, a surround left channel (Ls channel) and a surround right channel (Rs channel) are provided behind the listener. That is, five channels are provided in total so as to surround the listener. Moreover, a 0.1 channel is called low frequency effect (LFE) channel mainly corresponding to a low-pass component not greater than several hundred Hz.

Different speakers are connected to the respective channels. Especially, a dedicated speaker called subwoofer (SW) is connected to the LEF channel. The multichannel audio reproduction (i.e., surround reproduction) is realized by placing these speakers to surround the listener.

Most content to be reproduced by a surround reproduction system is the movies. In this field, with stereoscopic visualization of a video, sound reproduction also requires improvement in the representation of a depth direction.

However, in a household surround reproduction system, the size of a room limits a place where speakers are to be installed. Therefore, distances between the listener and the speakers are close in many cases. In this case, when audio signals are directly reproduced from the speakers, the surfaces of the speakers are sound sources. Therefore, a surround sound field where sound is reproduced is limited to a space surrounded by the speakers. Therefore, a problem is in that when content such as a movie is reproduced, it is difficult to reproduce a sound field having depth feel as if in a movie theater or a theater.

To solve the above problem, a technology is known in which a sound equivalent to a reflected sound is added to a direct sound emitted from a speaker to expand the sound field (e.g., Patent Literature 1).

### CITATION LIST

### Patent Literature

[PTL 1] Japanese Patent No. 4,196,509

### SUMMARY

### Technical Problem

In view of the above problem, the present disclosure provides an audio signal reproduction device which realizes the expansion of a sound field with further improved reproduced sound quality.

### Solution to Problem

To solve the above problems, the audio signal reproduction device according to the present disclosure is an audio signal reproduction device for causing speakers placed around a listener to output sounds. The audio signal reproduction device includes: a signal obtainment unit which obtains channel signals from channels each corresponding to a different one of the speakers, the channel signals including a channel signal representing a direct sound which reaches the listener from a predetermined direction; a reflected sound signal generation unit which, when a first area including a sound image of the direct sound and a second area which is an area other than the first area are two areas divided by a line orthogonal to the predetermined direction and passing through a position of the listener in a plan view of a space where the speakers are placed and the listener hears sound, generates a reflected sound signal representing a reflected sound from the channel signal representing the direct sound, the reflected sound being a sound which reaches the listener after the direct sound is reflected at a predetermined position in the second area; a signal generation unit which generates, from the reflected sound signal, a signal to be outputted to at least one of the channels, to cause at least one of the speakers to output a sound so that the listener perceives that the reflected sound comes from the predetermined position; and a signal output unit which adds each of at least one of the signals generated by the signal generation unit to a corresponding one of the channel signals obtained by the signal obtainment unit, to output an added signal.

### Advantageous Effects

According to an audio signal reproduction device in the present disclosure, not only a sound-field expanding effect is obtained, but also reproduced sound quality can be improved.

### BRIEF DESCRIPTION OF DRAWINGS

FIG. 1 is a figure for explaining the distance to the sound source which the listener feels from the direct sound and the reflected sound.

FIG. 2 is a block diagram showing a configuration of the audio signal reproduction device according to the embodiment.

FIG. 3 is a flowchart showing an operation of the audio signal reproduction device according to the embodiment.

FIG. 4 shows the relationship between the direct sound and the reflected sound in a desired sound field space, when viewed from above the listener.

FIG. 5 shows an example of a configuration to realize a desired sound field space.

FIG. 6 shows a method of generating a distribution signal using reflected sound vectors.

FIG. 7 shows a configuration of an audio system using the audio signal reproduction device according to the embodiment.

### DESCRIPTION OF EMBODIMENT(S)

### (Underlying Knowledge Forming Basis of the Present Disclosure)

A technology is known in which a sound equivalent to a reflected sound (hereinafter, referred to as “reflected-sound equivalent sound”) is added to a direct sound emitted from a speaker to expand a sound field. In general, people perceive a distance to a sound source based on a direct sound emitted from the sound source and a reflected sound from the surroundings. Therefore, the listener feels as if the sound source moved far away by outputting the direct sound and an appropriate reflected-sound equivalent sound.

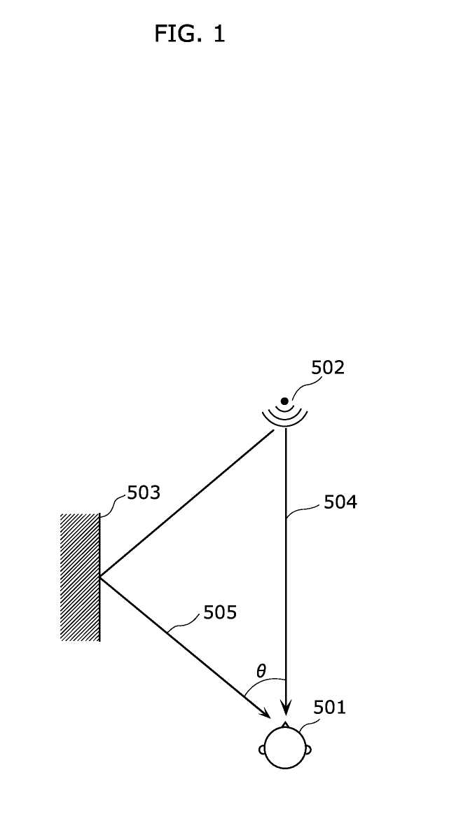

FIG. 1 is a figure for explaining the distance to the sound source which the listener feels from the direct sound and the reflected sound.

In FIG. 1, a direct sound 504 is the sound which directly reaches a listener 501, among sounds emitted radially from a sound source 502 ahead of the listener 501. Moreover, a reflected sound 505 is the sound which reaches the listener 501 after a sound emitted from the sound source 502 is reflected from a wall 503 provided in the front left of the listener 501. When the angle formed by the direction in which the direct sound 504 comes and the direction in which the reflected sound 505 comes is θ (degrees), the delay of the reflected sound 505 from the direct sound 504 is t (sec), and the speed of sound is v (m/sec), a distance d (m) from the listener 501 to the sound source 502 which the listener 501 feels is calculated by the following expression.

$$\begin{matrix}[ Math . 1 ] & \\ d = \frac{vt \cdot cos θ}{1 - cos θ} & ( Expression 1 )\end{matrix}$$

PTL 1 discloses the technology in which a sound field is expanded using a reflected-sound equivalent sound to reproduce a sound filed with depth feel by expressing a desired distance as shown in the above (Expression 1).

In the technology disclosed in PTL 1, a signal which has been delayed to represent the desired distance is generated from a multichannel audio signal corresponding to a direct sound, and a sound field is expanded by reproducing a reflected-sound equivalent sound. The reflected-sound equivalent sound created is distributed to speakers adjacent to the speaker which reproduces the original direct sound, and reproduced by the adjacent speakers. For instance, when a C channel speaker reproduces the original direct sound, L and R channel speakers each adjacent to a different side of the C channel speaker reproduce the reflected-sound equivalent sounds. Thus, the direct sound and the reflected-sound equivalent sounds are reproduced to expand the sound field without directly adding a signal representing the direct sound and signals representing the reflected-sound equivalent sounds.

However, the technology disclosed in PTL 1 has the following problem. The reflected-sound equivalent sounds are distributed to speakers each adjacent to a different side of the speaker which reproduces the original direct sound. Therefore, spatial interference between the direct sound and the reflected-sound equivalent sounds blurs a sound image.

Moreover, the direction in which the direct sound comes and the directions in which the reflected-sound equivalent sounds come from are close, physical interference of sound waves generated after the direct sound and the reflected-sound equivalent sounds are reproduced is high. For instance, the reflected-sound equivalent sound for the direct sound emitted from the C channel is reproduced from each of the L and R channels. Therefore, the phantom sound image of the reflected-sound equivalent sounds is present in a space between the L and R channels which includes the C channel. This causes comb filter effects, i.e., physical interference between the sound waves of the direct sound and the reflected-sound equivalent sounds. Therefore, reproduced sound quality is likely to be deteriorated.

To solve the above problems, the audio signal reproduction device according to the present disclosure is an audio signal reproduction device for causing speakers placed around a listener to output sounds. The audio signal reproduction device includes: a signal obtainment unit which obtains channel signals from channels each corresponding to a different one of the speakers, the channel signals including a channel signal representing a direct sound which reaches the listener from a predetermined direction; a reflected sound signal generation unit which, when a first area including a sound image of the direct sound and a second area which is an area other than the first area are two areas divided by a line orthogonal to the predetermined direction and passing through a position of the listener in a plan view of a space where the speakers are placed and the listener hears sound, generates a reflected sound signal representing a reflected sound from the channel signal representing the direct sound, the reflected sound being a sound which reaches the listener after the direct sound is reflected at a predetermined position in the second area; a signal generation unit which generates, from the reflected sound signal, a signal to be outputted to at least one of the channels, to cause at least one of the speakers to output a sound so that the listener perceives that the reflected sound comes from the predetermined position; and a signal output unit which adds each of at least one of the signals generated by the signal generation unit to a corresponding one of the channel signals obtained by the signal obtainment unit, to output an added signal.

Therefore, the direct sound comes from the first area while the reflected-sound equivalent sound comes from the second area. Accordingly, comb filter effects, i.e., physical interference between the direct sound and the reflected-sound equivalent sound are less likely to appear. This can improve reproduced sound quality. Furthermore, since the propagation paths of the direct sound and the reflected-sound equivalent sound are not the same, the listener can clearly perceive a sound image.

Moreover, in one aspect of the present disclosure, at least one speaker may be placed in the second area, and the signal generation unit may generate, from the reflected sound signal, the signal to be outputted to the at least one of the channels to cause the at least one of the speakers including the at least one speaker placed in the second area to output a sound so that the listener perceives that the reflected sound comes from the predetermined position.

Moreover, in one aspect of the present disclosure, at least one speaker may be placed in the first area, and the channel signal representing the direct sound may be a channel signal from a channel corresponding to the at least one speaker placed in the first area.

Moreover, in one aspect of the present disclosure, when the reflected sound signal is distributed to a first speaker and a second speaker, the signal generation unit may (i) resolve a reflected sound vector into a first vector and a second vector, the reflected sound vector representing a direction in which the reflected sound comes and an energy of the reflected sound, the first vector representing a first direction in which the first speaker outputs a sound, the second vector representing a second direction in which the second speaker outputs a sound, and (ii) generate signals to be outputted to channels corresponding to the first speaker and the second speaker so as to output, from the first speaker and the second speaker, sounds obtained through proportional distribution of the energy of the reflected sound based on magnitudes of the first vector and the second vector.

The proportional distribution enables more appropriate distribution of the reflected sound. Therefore, a much higher sound-field expanding effect can be obtained.

Moreover, in one aspect of the present disclosure, the first speaker and the second speaker may be placed in the second area.

Moreover, in one aspect of the present disclosure, the first area may be an area ahead of the listener, and the second area may be an area behind the listener.

This means that the direct sound comes from ahead of the listener, and the reflected-sound equivalent sound comes from behind the listener. Therefore, a sound-field expanding effect can be obtained ahead of the listener.

Moreover, the audio signal reproduction device according to the present disclosure is an audio signal reproduction device for causing front speakers placed in an area ahead of a listener and rear speakers placed in an area behind the listener to output sounds. The audio signal reproduction device may include: a signal obtainment unit which obtains channel signals from channels respectively corresponding to the front speakers and the rear speakers, the channel signals including a channel signal representing a direct sound which is emitted from the area ahead of the listener and reaches the listener from a predetermined direction by causing at least one of the front speakers to output a sound; a reflected sound signal generation unit which generates, from the channel signal representing the direct sound, a reflected sound signal representing a reflected sound which is a sound reaches the listener after the direct sound is reflected at a predetermined position in the area behind the listener; a signal generation unit which generates, from the reflected sound signal, signals to be outputted to the channels corresponding to the rear speakers to cause the rear speakers to output sounds so that the listener perceives that the reflected sound comes from the predetermined position; and a signal output unit which adds each of at least one of the signals generated by the signal generation unit to a corresponding one of the channel signals obtained by the signal obtainment unit, to output an added signal.

Moreover, the audio signal reproduction method according to the present disclosure is an audio signal reproduction method for causing speakers placed around a listener to output sounds. The audio signal reproduction method includes: obtaining channel signals from channels each corresponding to a different one of the speakers, the channel signals including a channel signal representing a direct sound which reaches the listener from a predetermined direction; when a first area including a sound image of the direct sound and a second area which is an area other than the first area are two areas divided by a line orthogonal to the predetermined direction and passing through a position of the listener in a plan view of a space where the speakers are placed and the listener hears sound, generating a reflected sound signal representing a reflected sound from the channel signal representing the direct sound, the reflected sound being a sound which reaches the listener after the direct sound is reflected at a predetermined position in the second area; generating, from the reflected sound signal, a signal to be outputted to at least one of the channels to cause at least one of the speakers to output a sound so that the listener perceives that the reflected sound comes from the predetermined position; and adding each of at least one of the signals generated by the signal generation unit to a corresponding one of the channel signals obtained by the signal obtainment unit, to output an added signal.

Hereinafter, certain exemplary embodiments are described in greater detail with reference to the accompanying Drawings. Each of the exemplary embodiments described below shows a general or specific example. The numerical values, shapes, structural elements, the arrangement and connection of the structural elements, steps, the processing order of the steps, and others shown in the following exemplary embodiments are mere examples, and therefore do not limit the scope of the present disclosure. Moreover, among the structural elements in the following exemplary embodiments, structural elements not recited in any one of the independent claims representing superordinate concept are not essential to achieve the problem of the present disclosure, but are used to form a more preferable embodiment.

### Embodiment

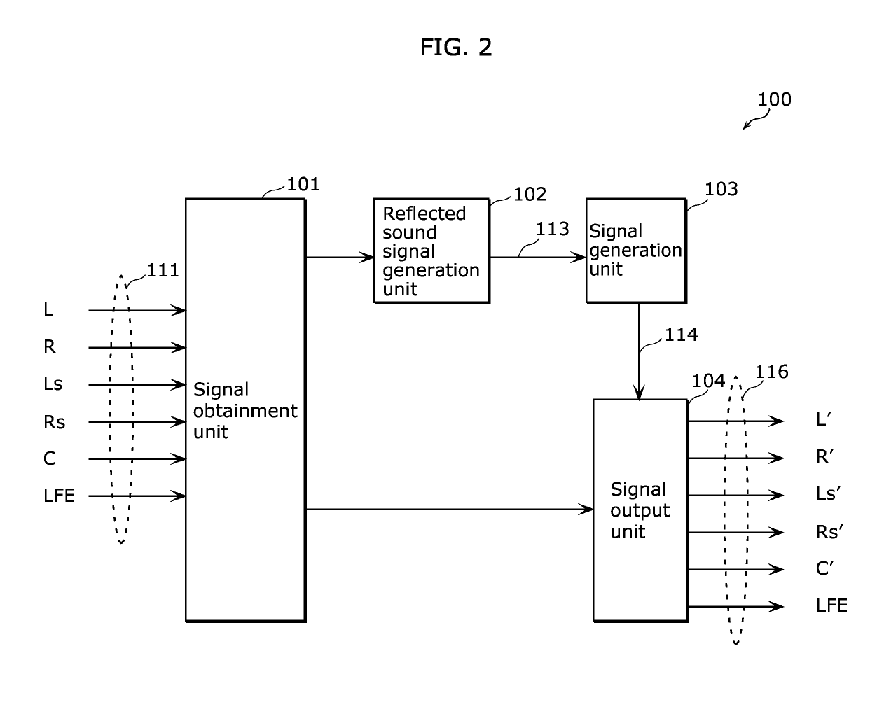

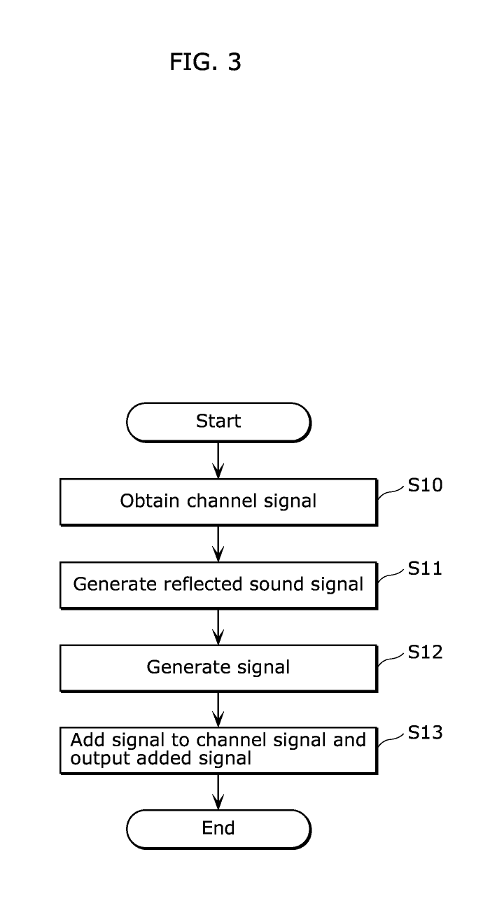

With reference to FIGS. 2 and 3, the following describes the configuration and operation of an audio signal reproduction device according to the present embodiment.

It should be noted that in the following description, unless otherwise mentioned, a direct sound is the sound which directly reaches a listener among sounds emitted from a sound source and radially diffused. Moreover, a reflected sound is the sound which is reflected at a predetermined position and reaches the listener among the sounds emitted from the sound source and radially diffused. That is, the direct sound and the reflected sound are different in direction and time in which/at which sound reaches the listener, sound pressure, and others. However, the direct sound and the reflected sound are substantially the same sound.

FIG. 2 is a block diagram showing a configuration of an audio signal reproduction device 100 according to the present embodiment. Moreover, FIG. 3 is a flowchart showing the operation of the audio signal reproduction device 100.

As shown in FIG. 2, the audio signal reproduction device 100 according to the present embodiment includes a signal obtainment unit 101, a reflected sound signal generation unit 102, a distribution signal generation unit 103, and a signal output unit 104. The signal obtainment unit 101 obtains an input channel signal 111. The reflected sound signal generation unit 102 generates a reflected sound signal 113 from a channel signal representing a direct sound. The distribution signal generation unit 103 generates, from the reflected sound signal 113, a distribution signal 114 to be distributed to at least one channel. The signal output unit 104 outputs an output channel signal 116.

The signal obtainment unit 101 obtains the input channel signal 111 representing content to be reproduced (S10). For example, for the 5.1-channel surround signal described above, the input channel signal 111 includes six channel signals. The six channel signals each correspond to one of speakers placed around the listener.

C in FIG. 2 represents a C channel signal. The C channel signal corresponds to a C channel speaker placed in front of the listener. L and R in FIG. 2 represent an L channel signal and an R channel signal, respectively. The L channel signal corresponds to an L channel speaker placed in the front left of the listener. The R channel signal corresponds to an R channel speaker placed in the front right of the listener. Likewise, Ls and Rs in FIG. 2 represent an Ls channel signal and an Rs channel signal, respectively. The Ls channel signal corresponds to an Ls channel speaker placed in the rear left of the listener. The Rs channel signal corresponds to an Rs channel speaker placed in the rear right of the listener. LFE in FIG. 2 represents an LFE channel signal. The LFE channel signal mainly contains a low frequency component not greater than several hundred Hz, and can be received by a subwoofer

The reflected sound signal generation unit 102 generates the reflected sound signal 113 representing the primary reflected sound of a direct sound (hereinafter, referred to as “reflected sound”), using a channel signal representing the direct sound (S11). The specific method of generating a reflected sound signal will be described later.

The distribution signal generation unit 103 generates the distribution signal 114 to be outputted to at least one channel, from the reflected sound signal 113 (S12). The method of generating the distribution signal 114 will be described later.

The signal output unit 104 outputs the output channel signal 116 obtained by adding, for each channel, corresponding one of the input channel signals 111 and a corresponding one of the distribution signals 114 (S13). Specifically, the signal output unit 104 directly outputs the input channel signal 111 of the channel for which the distribution signal 114 is not generated, among the input channel signals 111 obtained by the signal obtainment unit 101. Meanwhile, the signal output unit 104 outputs a signal obtained by adding the distribution signal 114 to the channel signal 111 of the channel for which the distribution signal 114 is generated, among the input channel signals 111.

For example, for the 5.1-channel surround signal described above, the output channel signal 116 includes six channel signals. The six channel signals each correspond to one of the speakers placed around the listener. C′ in FIG. 2 represents a C′ channel signal. The C′ channel signal corresponds to a C channel speaker placed in front of the listener. L′ and R′ in FIG. 2 represent an L′ channel signal and an R′ channel signal, respectively. The L′ channel signal corresponds to the L channel speaker placed in the front left of the listener. The R′ channel signal corresponds to the R channel speaker placed in the front right of the listener. Likewise, Ls′ and Rs′ in FIG. 2 represent an Ls′ channel signal and an Rs′ channel signal, respectively. The Ls′ channel signal corresponds to the Ls channel speaker placed in the rear left of the listener. The Rs′ channel signal corresponds to the Rs channel speaker placed in the rear right of the listener. The LFE in FIG. 2 represents the LFE channel signal.

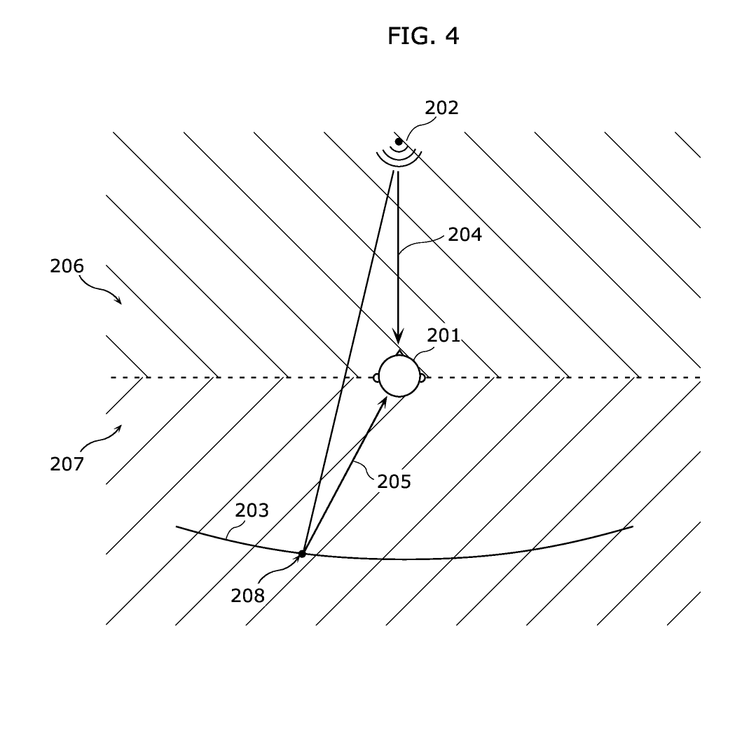

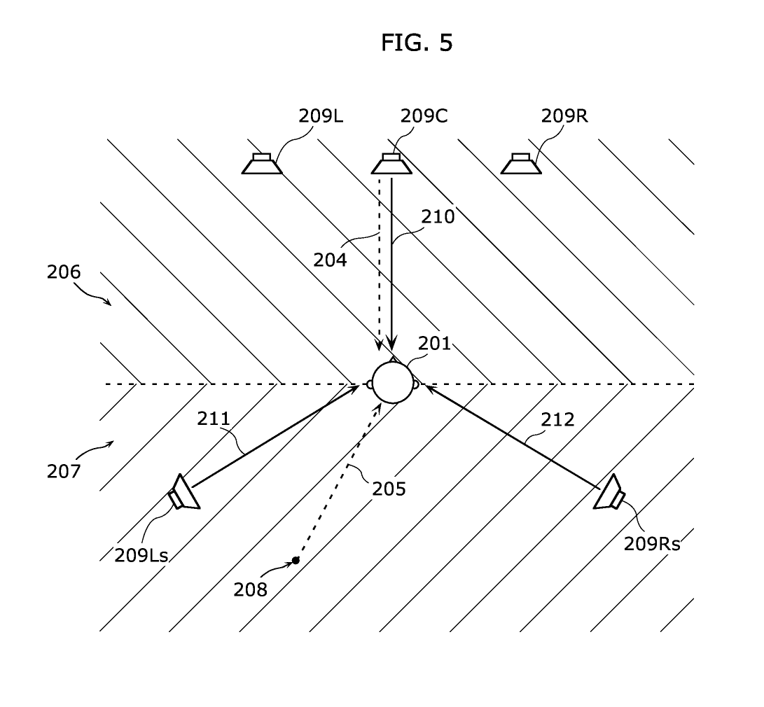

With reference to FIGS. 4 and 5, the following details the operations of the structural elements of the audio signal reproduction device 100, for realizing a desired sound field space.

FIG. 4 shows the relationship between a direct sound and a reflected sound in the desired sound field space, when viewed from above the listener.

A direct sound 204 shown in FIG. 4 is the sound which directly reaches a listener 201 among sounds emitted from a sound source (sound image) 202 ahead of the listener 201.

As shown in FIG. 4, the audio signal reproduction device 100 virtually divides the space around the listener 201 into a first area 206 and a second area 207. The first area 206 is the area which includes the sound source 202 among the areas divided by a line orthogonal to the direction in which the direct sound 204 comes and passing through the listener 201. The second area 207 is on the other side of the line.

In the sound field space in FIG. 4, the sound source 202 is ahead of the listener 201. Therefore, the first area 206 is an area ahead of the listener 201. The second area 207 is an area behind the listener 201.

Moreover, an arcuate wall 203 provided in the second area 207 is a wall virtually provided by the audio signal reproduction device 100.

A reflected sound 205 is the sound which reaches the listener 201 after the direct sound emitted from the sound source 202 in the first area 206 is reflected at a predetermined reflection position 208 in the wall 203 provided in the second area 207. It should be noted that the direct sound, i.e., the original sound of the reflected sound 205 is a sound emitted from the sound source 202 toward the reflection position 208 (i.e., a sound equivalent to (same as) the direct sound 204) among sounds emitted from the sound source 202 and radially diffused.

FIG. 5 shows an example of the configuration for realizing the sound field space as shown in FIG. 4.

To realize the sound field space as shown in FIG. 4, speakers corresponding to the 5.1 surround signals described above are provided around the listener. Specifically, a C channel speaker 209C is placed in front of the listener 201. Likewise, an L channel speaker 209L is placed in the front left of the listener 201. An R channel speaker 209R is placed in the front right of the listener 201. Moreover, an Ls channel speaker 209Ls is placed in the rear left of the listener 201. An Rs channel speaker 209Rs is placed in the rear right of the listener 201. It should be noted that although not shown in FIG. 5, a subwoofer is also installed.

The signal obtainment unit 101 obtains the input channel signals 111. It should be noted that the following description is based on the assumption that only the direct sound 204 and a sound equivalent to the reflected sound 205 are outputted from the speakers in FIG. 5. That is, the following description is based on the assumption that among the input channel signals 111 obtained by the signal obtainment unit 101, the C channel signal represents the direct sound 204, and the other channel signals represent zero.

The reflected sound signal generation unit 102 generates the reflected sound signal 113 representing the reflected sound 205 from the channel signal representing the direct sound 204 outputted from the C channel speaker 209C. Specifically, the reflected sound signal 113 is generated by delaying and attenuating the C channel signal representing a direct sound 210.

The delay amount between the direct sound 204 and the reflected sound 205 is determined based on (i) the difference between the path in which the direct sound 204 reaches the listener 201 and the path in which the reflected sound 205 reaches the listener 201 and (ii) sound speed. Moreover, the attenuation amount between the direct sound 204 and the reflected sound 205 is, for example, determined by the reflection rate of a sound when reflected from the wall 203 which is preset in the reflected sound signal generation unit 102.

It should be noted that in addition to determining the delay amount and attenuation amount, the reflected sound signal 113 may be generated by performing signal processing on the C channel signal representing the direct sound 210. For instance, the reflected sound signal 113 may be generated by adding a frequency characteristic to the C channel signal representing the direct sound 210 (using an equalizer).

Moreover, multiple reflection of sound is repeated in actual environment. Therefore, many reflected sounds reach the listener 201. Among such reflected sounds, a primary reflected sound with the highest intensity largely influences the perception of a distance. Therefore, the reflected sound signal generation unit 102 may only generate the reflected sound signal 113 representing the primary reflected sound among the reflected sounds 205.

It should be noted that FIG. 4 shows the arcuate wall 203 as an example. However, the shape of the wall 203 is arbitrary. For example, the reflected sound signal generation unit 102 may generate the reflected sound signal 113 representing a sound reflected from the wall 203 of a flat surface or an uneven surface.

The reflected sound 205 represented by the reflected sound signal 113 should be ideally outputted from a speaker placed at the reflection position 208. However, the speakers placed around the listener 201 are generally fixed at predetermined positions, for example as shown in FIG. 5.

Therefore, the distribution signal generation unit 103 distributes the reflected sound signal(s) 113 to one or more channels so that the listener 201 can hear the reflected sound 205 from the reflection position 208. In this example, to cause the Ls channel speaker 209Ls and the Rs channel speaker 209Rs to output sounds, the distribution signal generation unit 103 generates, from the reflected sound signal 113, the distribution signals 114 to be outputted to the channels respectively corresponding to the Ls channel speaker 209Ls and the Rs channel speaker 209Rs. More specifically, the distribution signal generation unit 103 generates the distribution signal 114 representing a first sound 211 outputted from the Ls channel speaker 209Ls and the distribution signal 114 representing a second sound 212 outputted from the Rs channel speaker 209Rs.

The signal output unit 104 obtains the input channel signals 111 from the signal obtainment unit 101, and obtains the distribution signals 114 from the distribution signal generation unit 103. The signal output unit 104 adds, for each channel, a corresponding one of the obtained input channel signals 111 and a corresponding one of the obtained distribution signals 114 to generate and output the output channel signal 116.

In the above example, the signal output unit 104 outputs the C channel signal obtained from the signal obtainment unit 101 as the C′ channel signal. The signal output unit 104 outputs, as the Ls′ channel signal, the Ls channel signal to which the distribution signal 114 representing the first sound 211 and obtained from the distribution signal generation unit 103 is added. The signal output unit 104 outputs, as the Rs′ channel signal, the Rs channel signal to which the distribution signal 114 representing the second sound 212 and obtained from the distribution signal generation unit 103 is added.

That is, the listener 201 hears the direct sound 210 outputted from the C channel speaker 209C. Moreover, the listener 201 feels as if the reflected sound 205 came from the reflection position 208 when hearing the first sound 211 outputted from the Ls channel speaker 209Ls and the second sound 212 outputted from the Rs channel speaker 209Rs.

Thus, the direct sound 210 comes from ahead of the listener 201, and the first sound 211 and the second sound 212 equivalent to the reflected sounds 205 come from behind. Therefore, comb filter effects, i.e., physical interference between the direct sound 210 and sounds equivalent to the reflected sounds 205 are less likely to appear. This can improve reproduced sound quality. Furthermore, the sound propagation paths of the direct sound 210 and the first sound 211 are not the same, and the sound propagation paths of the direct sound 210 and the second sound 212 are not the same. Therefore, the listener 201 can clearly perceive the sound source.

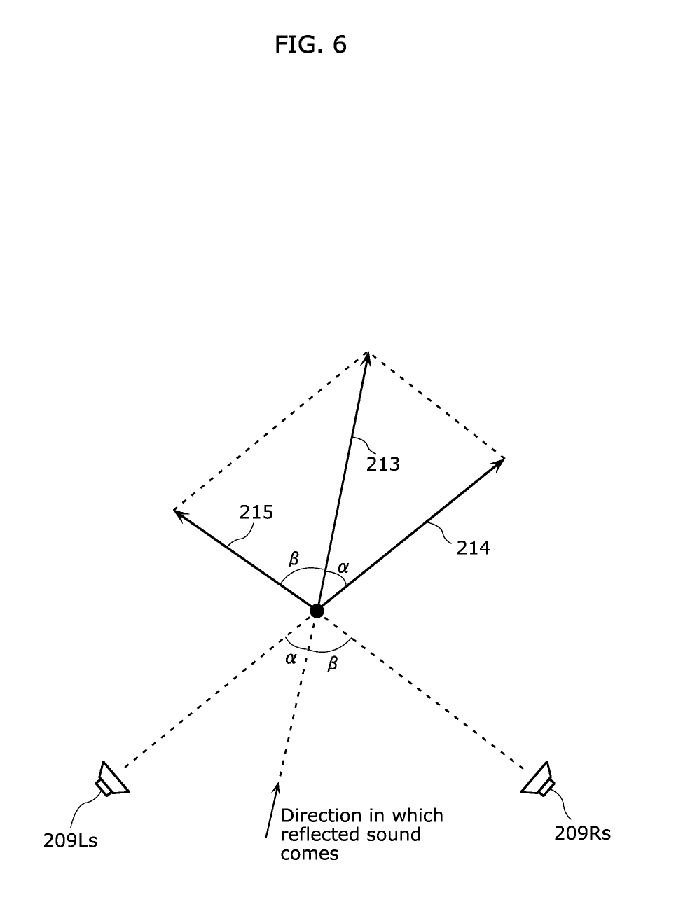

With reference to FIG. 6, the following describes the method of generating the distribution signals 114. FIG. 6 shows the method of generating the distribution signals 114 using a reflected sound vector according to the present embodiment. It should be noted that the distribution signals 114 according to the present embodiment are generated as signals obtained by changing the amplitude of the reflected sound signal 113 using a reflected sound vector representing the reflected sound 205.

The direction of a reflected sound vector 213 in FIG. 6 shows the direction in which the reflected sound 205 comes. Moreover, the magnitude of the reflected sound vector 213 represents the energy of the reflected sound 205.

When the reflected sound signal 113 is distributed to the Ls channel speaker 209Ls which is a first speaker and the Rs channel speaker 209Rs which is a second speaker, the distribution signal generation unit 103 resolves the reflected sound vector 213 into the first vector 214 and the second vector 215 to generate the distribution signals 114 based on the respective vectors.

The first vector 214 represents the direction in which the Ls channel speaker 209Ls outputs a sound. An angle α shown in FIG. 6 is formed by the first vector 214 and the reflected sound vector 213. Likewise, the second vector 215 represents the direction in which the Rs channel speaker 209Rs outputs a sound. An angle β shown in FIG. 6 is formed by the second vector 215 and the reflected sound vector 213. Here, when m:n is the ratio of the magnitudes of the first vector 214 and the second vector 215, respective values can be calculated by the following expressions.

$$\begin{matrix}[ Math . 2 ] & \\ m = cos α - sin α \cdot tan \{ \frac{π}{2} - ( α + β ) \} & ( Expression 2 ) \\ [ Math . 3 ] & \\ n = cos β - sin β \cdot tan \{ \frac{π}{2} - ( α + β ) \} & ( Expression 3 )\end{matrix}$$

Moreover, the volume of a sound perceived by the listener 201 is defined by the total energy of the sounds which reach the listener 201. Therefore, when the energy of the reflected sound 205 is Er, the energy of the first sound 211 is Em, and the energy of the second sound 212 is En, the following expression holds.

[Math. 4]

Er=Em+En (Expression 4)

The energy Em and the energy En can be calculated as shown in the following expressions from the energy Er of the reflected sound, based on Expression 2, Expression 3, and Expression 4.

$$\begin{matrix}[ Math . 5 ] & \\ Em = \frac{m}{m + n} \cdot Er & ( Expression 5 ) \\ [ Math . 6 ) & \\ En = \frac{n}{m + n} \cdot Er & ( Expression 6 )\end{matrix}$$

The amplitudes (gains) of the distribution signals 114 to be distributed to the channels corresponding to the Ls channel speaker 209Ls and the Rs channel speaker 209Rs, respectively are adjusted based on the energy Em and the energy En calculated by Expression 5 and Expression 6.

That is, the distribution signal generation unit 103 generates the distribution signals 114 to be outputted to the channels respectively corresponding to the Ls channel speaker 209Ls and the Rs channel speaker 209Rs so as to output, from the Ls channel speaker 209Ls and the Rs channel speaker 209Rs, sounds obtained through proportional distribution of the energy of the reflected sound 205 as shown in Expression 5 and Expression 6.

Thus, more accurate distribution signals 114 are generated by using the reflected sound vector 213. Therefore, a sound field can be expanded more effectively.

It should be noted that with reference to FIGS. 4 and 5, an example was described in which the direct sound 204 is realized only by output from the C channel speaker 209C. However, the method of realizing the direct sound 204 is not limited to this example.

For instance, the direct sound 204 may be one of the sounds outputted from the C channel speaker 209C, L channel speaker 209L, and the R channel speaker 209R. It should be noted that in this case, channel signals forming the direct sounds 210 are the C channel signal, the L channel signal, and the R channel signal.

Moreover, the sound source does not have to be positioned ahead of the listener 201. For instance, the sound source may be positioned in the rear left of the listener 201. In this case, the audio signal reproduction device 100 divides the space around the listener 201 into two virtual areas by a line orthogonal to the direction in which a direct sound emitted from the sound source in the rear left reaches the listener 201. The reflected sound in this case is a sound obtained when the direct sound from the sound source in the rear left is reflected at a predetermined position in the area of the divided areas which does not include the sound source.

In the above case, the direct sound from the sound source in the rear left which reaches the listener is, for example, realized by causing the Ls channel speaker 209Ls to output a sound. The reflected sound is, for example, realized by causing the C channel speaker 209C and the R channel speaker 209R to output sounds.

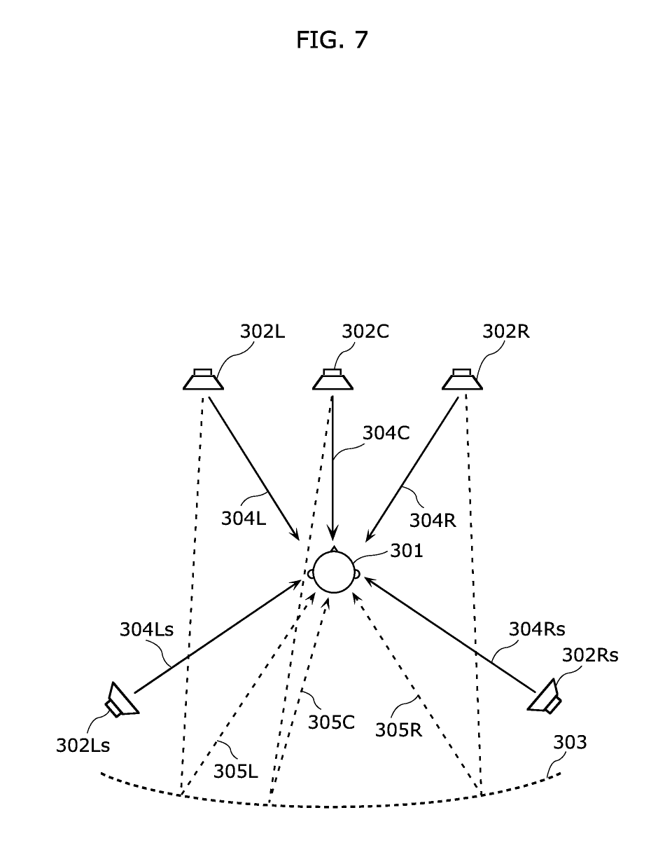

With reference to FIG. 7, the following describes the more specific operation of the audio signal reproduction device 100 according to the present embodiment. FIG. 7 shows the configuration of an audio system using the audio signal reproduction device 100.

FIG. 7 illustrates speakers placed around the listener 301 when viewed from above the listener 301. A C channel speaker 302C is placed in front of the listener 301. Likewise, an L channel speaker 302L is placed in the front left of the listener 301. An R channel speaker 302R is placed in the front right of the listener 301. Moreover, an Ls channel speaker 302Ls is placed in the rear left of the listener 301. An Rs channel speaker 302Rs is placed in the rear right of the listener 301.

Moreover, a virtual wall 303 is shown in FIG. 7. It should be noted that although not shown in FIG. 7, a subwoofer is also placed.

The reflected sound signal generation unit 102 generates the reflected sound signal 113 representing a reflected sound 305C from the C channel signal. Here, the reflected sound 305C is the sound which reaches the listener 301 after a direct sound from the C channel speaker 302C is reflected at a predetermined position in the virtual wall 303. It should be noted that the direct sound to be the original of the reflected sound 305C is a sound emitted from the C channel speaker 302C toward the predetermined position (i.e., the sound equivalent to (same as) a direct sound 304C shown in FIG. 7), among sounds emitted from the C channel speaker 302C and radially diffused.

Likewise, the reflected sound signal generation unit 102 generates the reflected sound signal 113 representing a reflected sound 305L from the L channel signal. Here, the reflected sound 305L is a sound obtained when a direct sound from the L channel speaker 302L is reflected from the wall 303. The direct sound to be the original of the reflected sound 305L is a sound emitted from the L channel speaker 302L toward a predetermined position (i.e., the sound equivalent to (same as) a direct sound 304L), among sounds emitted from the L channel speaker 302L and radially diffused.

Moreover, the reflected sound signal generation unit 102 generates the reflected sound signal 113 representing a reflected sound 305R from the R channel signal. Here, the reflected sound 305R is a sound obtained when a direct sound from the R channel speaker 302R is reflected from the wall 303. The direct sound to be the original of the reflected sound 305R is a sound emitted from the R channel speaker 302R toward a predetermined position (i.e., the sound equivalent to (same as) a direct sound 304R), among sounds emitted from the R channel speaker 302R and radially diffused.

The distribution signal generation unit 103 generates, from the reflected sound signal 113 representing the reflected sound 305C, the distribution signals 114 to be outputted to the Ls channel and the Rs channel so that the listener 301 can hear the reflected sound 305C from the predetermined direction. Likewise, the distribution signal generation unit 103 generates the distribution signals 114 to be outputted to the Ls channel and the Rs channel, using the reflected sound signals 113 respectively representing the reflected sound 305L and the reflected sound 305R. Specifically, as described above, the distribution signal generation unit 103 generates the distribution signals 114 using the reflected sound vectors corresponding to the reflected sound signals 113 respectively representing the reflected sounds 305C, 305L, and 305R.

The signal output unit 104 directly outputs the C channel signal, the L channel signal, and the R channel signal to the channels corresponding to these channel signals, among the input channel signals 111 obtained by the signal obtainment unit 101. That is, the C channel signal is outputted to the C channel as the C′ channel signal. Moreover, the L channel signal is outputted to the L channel as the L′ channel signal. The R channel signal is outputted to the R channel as the R′ channel signal. As a result, the C channel speaker 302C outputs the direct sound 304C. The L channel speaker 302L outputs the direct sound 304L. The R channel speaker 302R outputs the direct sound 304R. (Hereinafter, the direct sounds 304, 304L, and 304R are collectively called direct sounds 304.)

Moreover, the distribution signals 114 are added to the Ls channel signal and the Rs channel signal obtained by the signal obtainment unit 101. Here, the distribution signals 114 are generated from the reflected sound signals 113 representing the reflected sounds 305C, 305L, and 305R (hereinafter, these sounds are collectively called reflected sounds 305). After the distribution signal 114 is added, the Ls channel signal is outputted as the Ls′ channel signal to the Ls channel. Likewise, after the distribution signal 114 is added, the Rs channel signal is outputted as the Rs′ channel signal to the Rs channel. As a result, the Ls channel speaker outputs a sound 304Ls, and the Rs channel speaker outputs a sound 304Rs.

The listener 301 feels as if the virtual wall 303 was behind when hearing the direct sound 304 and the sounds 304Ls and 304Rs coming from behind which include sounds equivalent to the reflected sounds 305. It is experimentally confirmed that this makes the listener 301 feel as if the sound source of the direct sound 304 coming from ahead was more distant from the listener 301 than the actual sound source. That is, the sound-field expanding effect can be obtained ahead of the listener 301.

Moreover, the direct sound 304 comes from ahead of the listener 301, and the sound 304Ls and the sound 304Rs which include sounds equivalent to the reflected sounds 305 come from behind of the listener. Therefore, comb filter effects, i.e., physical interference between the direct sound 304 and the sounds equivalent to the reflected sounds 305 are less likely to appear. This can improve reproduced sound quality. Moreover, the propagation paths of the direct sound 304 and sounds equivalent to the reflected sounds 305 are not the same. Therefore, the listener 301 can clearly perceive the sound source.

It should be noted that in the configuration in FIG. 7, a reflected sound for a direct sound emitted from each speaker placed ahead of the listener has one path. However, there may be more than one path of the reflected sound. That is, the reflected sound signal generation unit 102 may generate the reflected sound signals 113 representing reflected sounds for a direct sound from one speaker.

Moreover, the reflected sound signal generation unit 102 may generate the reflected sound signal 113 representing the reflected sound which reaches the listener 301 after a direct sound obtained from a sound image formed by direct sounds from speakers is reflected from the virtual wall 303.

It should be noted that in the present embodiment, the Ls channel speaker and the Rs channel speaker are placed behind the listener. However, these two speakers do not have to be placed. Even in such a case, it is possible to output a sound from behind the listener by a speaker placed ahead of the listener emitting a sound toward an actual wall behind the listener to generate a reflected sound from the actual wall. That is, in this case, the reflected sound from the virtual wall can be realized by the reflected sound from the actual wall.

Furthermore, the present disclosure can be modified as below.

(1) Each of the above devices is specifically a computer system including a microprocessor, a ROM, a RAM, a hard disk unit, a display unit, a keyboard, and a mouse. The RAM or hard disk unit stores a computer program. When the microprocessor operates in accordance with the computer program, each device achieves its function. Here, the computer program combines operations codes indicating instructions for the computer, to achieve a predetermined function.

(2) A part or all of structural elements making up each device may be one system large scale integration (LSI). The system LSI is a super multifunctional LSI manufactured by integrating structural units into one chip, and is in particular a computer system including a microprocessor, a ROM, and a RAM. The RAM stores a computer program. When the microprocessor operates in accordance with the computer program, the system LSI achieves its function.

(3) A part or all of structural elements making up each device described above may be an IC card or single module attachable to and detachable from each device. The IC card or the module is a computer system including a microprocessor, a ROM, and a RAM. The IC card or the module may include the super multifunctional LSI. When the microprocessor operates in accordance with the computer program, the IC card or the module achieves its function. This IC card or module may be tamper resistant.

(4) The present disclosure may be the methods described above. Moreover, the present disclosure may be a computer program which realizes these methods by a computer, or may be digital signals formed by the computer program.

Moreover, the present disclosure may be achieved by storing the computer program or the digital signal in a computer-readable recording medium including, for example, a flexible disk, a hard disk, a CD-ROM, a MO, a DVD, a DVD-ROM, a DVD-RAM, a Blu-ray (registered trademark) (BD) disc, and a semiconductor memory. Moreover, the present disclosure may be the digital signal stored in these recording media.

Moreover, the present disclosure may be achieved by transmitting the computer program or the digital signal through, for example, a telecommunications line, a wireless or wired communication line, a network represented by the Internet, or data broadcasting.

Moreover, the present disclosure may be a computer system including a microprocessor and a memory. The memory may store the computer program. The microprocessor may operate in accordance with the computer program.

Moreover, the present disclosure may be implemented by another independent computer system by storing in the recording medium and transferring the program or the digital signal or by transferring the program or the digital signal via the network or the like.

(5) The embodiment and each of the modifications may be combined.

The audio signal reproduction device according to one aspect of the present disclosure was described based on the embodiment and modifications thereof. According to the audio signal reproduction device in the present disclosure, a sound-field expanding effect can be obtained by adding a direct sound coming from one side of the listener and a sound equivalent to a reflected sound coming from the other side of the listener. Moreover, when the direct sound and the sound equivalent to the reflected sound come from different directions, interference between the direct sound and the sound equivalent to the reflected sound can be suppressed. This can improve reproduced sound quality.

It should be noted that the present disclosure is not limited to the embodiment or modifications thereof. The present disclosure includes an embodiment obtained by making various modifications which those skilled in the art would conceive to the present embodiment or an embodiment obtained by combining structural elements of different embodiments or modifications thereof unless such embodiment does not depart from the scope of the present disclosure.

### INDUSTRIAL APPLICABILITY

The audio signal reproduction device in the present disclosure can be used as an audio signal reproduction device capable of realizing in particular the high sound quality of a sound filed close to an actual movie theater or a theater in a theater system for general household use, for example.

1. An audio signal reproduction device for causing speakers placed around a listener to output sounds, the audio signal reproduction device comprising:
a signal obtainment unit configured to obtain channel signals from channels each corresponding to a different one of the speakers, the channel signals including a channel signal representing a direct sound which reaches the listener from a predetermined direction;
a reflected sound signal generation unit configured to, when a first area including a sound image of the direct sound and a second area which is an area other than the first area are two areas divided by a line orthogonal to the predetermined direction and passing through a position of the listener in a plan view of a space where the speakers are placed and the listener hears sound, generate a reflected sound signal representing a reflected sound from the channel signal representing the direct sound, the reflected sound being a sound which reaches the listener after the direct sound is reflected at a predetermined position in the second area;
a signal generation unit configured to generate, from the reflected sound signal, a signal to be outputted to at least one of the channels, to cause at least one of the speakers to output a sound so that the listener perceives that the reflected sound comes from the predetermined position; and
a signal output unit configured to add each of at least one of the signals generated by the signal generation unit to a corresponding one of the channel signals obtained by the signal obtainment unit, to output an added signal.

2. The audio signal reproduction device according to claim 1,
wherein at least one speaker is placed in the second area, and
the signal generation unit is configured to generate, from the reflected sound signal, the signal to be outputted to the at least one of the channels to cause the at least one of the speakers including the at least one speaker placed in the second area to output a sound so that the listener perceives that the reflected sound comes from the predetermined position.

3. The audio signal reproduction device according to claim 1,
wherein at least one speaker is placed in the first area, and
the channel signal representing the direct sound is a channel signal from a channel corresponding to the at least one speaker placed in the first area.

4. The audio signal reproduction device according to claim 1,
when the reflected sound signal is distributed to a first speaker and a second speaker,
the signal generation unit is configured to
resolve a reflected sound vector into a first vector and a second vector, the reflected sound vector representing a direction in which the reflected sound comes and an energy of the reflected sound, the first vector representing a first direction in which the first speaker outputs a sound, the second vector representing a second direction in which the second speaker outputs a sound, and
generate signals to be outputted to channels corresponding to the first speaker and the second speaker so as to output, from the first speaker and the second speaker, sounds obtained through proportional distribution of the energy of the reflected sound based on magnitudes of the first vector and the second vector.

5. The audio signal reproduction device according to claim 4,
wherein the first speaker and the second speaker are placed in the second area.

6. The audio signal reproduction device according to claim 1,
wherein the first area is an area ahead of the listener, and
the second area is an area behind the listener.

7. An audio signal reproduction device for causing front speakers placed in an area ahead of a listener and rear speakers placed in an area behind the listener to output sounds, the audio signal reproduction device comprising:
a signal obtainment unit configured to obtain channel signals from channels respectively corresponding to the front speakers and the rear speakers, the channel signals including a channel signal representing a direct sound which is emitted from the area ahead of the listener and reaches the listener from a predetermined direction by causing at least one of the front speakers to output a sound;
a reflected sound signal generation unit configured to generate, from the channel signal representing the direct sound, a reflected sound signal representing a reflected sound which is a sound reaches the listener after the direct sound is reflected at a predetermined position in the area behind the listener;
a signal generation unit configured to generate, from the reflected sound signal, signals to be outputted to the channels corresponding to the rear speakers to cause the rear speakers to output sounds so that the listener perceives that the reflected sound comes from the predetermined position; and
a signal output unit configured to add each of at least one of the signals generated by the signal generation unit to a corresponding one of the channel signals obtained by the signal obtainment unit, to output an added signal.

8. An audio signal reproduction method for causing speakers placed around a listener to output sounds, the audio signal reproduction method comprising:
obtaining channel signals from channels each corresponding to a different one of the speakers, the channel signals including a channel signal representing a direct sound which reaches the listener from a predetermined direction;
when a first area including a sound image of the direct sound and a second area which is an area other than the first area are two areas divided by a line orthogonal to the predetermined direction and passing through a position of the listener in a plan view of a space where the speakers are placed and the listener hears sound, generating a reflected sound signal representing a reflected sound from the channel signal representing the direct sound, the reflected sound being a sound which reaches the listener after the direct sound is reflected at a predetermined position in the second area;
generating, from the reflected sound signal, a signal to be outputted to at least one of the channels to cause at least one of the speakers to output a sound so that the listener perceives that the reflected sound comes from the predetermined position; and
adding each of at least one of the signals generated by the signal generation unit to a corresponding one of the channel signals obtained by the signal obtainment unit, to output an added signal.

9. A computer-readable non-transitory recording medium having recorded thereon a program for causing a computer to execute the audio signal reproduction method according to claim 8.
